(19) United States
(12) Patent Application Publication
(10) Pub. No.: US 2014/0279214 A1
(43) Pub. Date: Sep. 18, 2014

(54) Persistent and Unified Electronic Shopping Cart

(71) Applicants: David Alexander Wagoner-Edwards, Brooklyn, NY (US); Aanarav Sareen, New York, NY (US)

(72) Inventors: David Alexander Wagoner-Edwards, Brooklyn, NY (US); Aanarav Sareen, New York, NY (US)

(21) Appl. No.: 13/840,177

(22) Filed: Mar. 15, 2013

(51) Int. Cl. G06Q 30/06

(52) U.S. Cl. CPC G06Q 30/0633
USPC 705/26.8

(57) ABSTRACT

A persistent, unified electronic shopping cart that permits a user to select and aggregate goods or services for future purchase from two or more unrelated e-commerce websites, display and modify the content of the electronic shopping cart, and then complete the purchase of the goods or services through the one electronic shopping cart. The user of the persistent, unified electronic shopping cart is able to add and remove items from the electronic shopping cart, compare the prices, shipping and taxes for items from different e-commerce sites, move items to a wish list and see the total for all purchases at the same time.

### CROSS-REFERENCE TO RELATED APPLICATIONS

The present application claims benefit to the filing date of Provisional Application No. 61/635,764, filed on Apr. 19, 2012.

### TECHNICAL FIELD OF THE INVENTION

The present invention relates generally to the aggregation of electronic ordering information in an electronic shopping cart that permits a single checkout process from multiple e-commerce retailers. More specifically, a persistent and unified electronic shopping cart permits a user to add items for purchase to the electronic shopping cart from unrelated websites and then perform a single checkout process to purchase the items from all of the unrelated websites.

### BACKGROUND OF THE INVENTION

E-commerce websites and electronic shopping carts provide an on-line method for purchasing goods and services. When a user browses an electronic commerce website, the user may select items for purchase. These items are then placed in the user's electronic shopping cart, which is owned and powered by the electronic commerce website. A description of the item, the quantity, and the price of the one or more items in the user's electronic shopping cart are displayed to the user, typically along with other information such as estimated taxes, shipping costs and a total amount for the transaction. When the user is done shopping within the particular e-commerce site, the user then goes through a “checkout” procedure, where the user enters payment, billing and shipping information, or logs in using credentials identifying the user and retrieving previously stored billing and shipping information.

Various means and methods have been employed to improve electronic shopping carts. For example the prior art provides for a number of e-commerce shopping cart solutions:
U.S. Pat. No. 6,405,176 issued on Jun. 11, 2002 to Toohey describes a method for processing electronic shopping carts in an electronic mall.
U.S. Pat. No. 7,890,379 issued on Feb. 15, 2011 to Kreiner, et al describes a system where an electronic system inspects different records from different merchants.
U.S. Pat. No. 7,072,859 issued on Jul. 4, 2006 to Huber describes a system where the items selected from a manufacturer's shopping cart are forwarded to a retail shopping cart.

The electronic shopping carts are typically implemented within the e-commerce site or family of inter-related e-commerce sites. However, it would be advantageous if a user could add items from multiple unrelated websites to the user's electronic shopping cart and perform a single checkout procedure to effectuate the purchase of the items.

Therefore, it is with respect to these considerations and others that the present invention has been made.

### BRIEF DESCRIPTION OF THE DRAWINGS

FIG. 1 is a system diagram of one embodiment of an environment in which the invention may be practiced;

FIG. 2 shows one embodiment of a network device that may be included in a system implementing the invention;

FIG. 3A shows the client-side interface in a browser, where the browser is accessing an e-commerce website;

FIG. 3B shows a close up of the client-side interface in the browser;

FIG. 4 illustrates a logical flow diagram showing one embodiment of a persistent, unified electronic shopping cart;

FIG. 5 shows the sign-in screen for the client-side interface in the browser;

FIG. 6 shows the home screen for the client-side interface in the browser;

FIG. 7 depicts a first e-commerce website accessed through a browser where the user may add an item to the persistent, unified electronic shopping cart;

FIG. 8 illustrates the persistent, unified electronic shopping cart pop-up providing the contents of the cart, including a first item that was placed in the cart;

FIG. 9 depicts a second e-commerce website accessed through a browser where the user may add an item to the persistent, unified electronic shopping cart;

FIG. 10 illustrates the persistent, unified electronic shopping cart in an expanded state, providing the contents of the cart, including a second item placed in the cart;

FIG. 11 depicts a third e-commerce website accessed through a browser where the user may add an item to the persistent, unified electronic shopping cart;

FIG. 12 illustrates the persistent electronic shopping cart in an expanded state, providing the contents of the cart including a third item placed in the cart;

FIG. 13 illustrates the removal of an item from the persistent, unified electronic shopping cart;

FIG. 14 shows a first checkout screen;

FIG. 15 shows a different state of the shopping cart for entering payment information;

FIG. 16 shows a screen depicting the final order information; and

FIG. 17 is diagram showing the communication between the client device, e-commerce websites and persistent, unified electronic cart server.

### DETAILED DESCRIPTION

Various embodiments will now be described with reference to the accompanying drawings, which form a part of the description, and which show, by way of illustration, specific embodiments. However, this invention may be embodied in many different forms and should not be construed as limited to the embodiments set forth herein. Rather, these embodiments are provided so that this disclosure will be thorough and complete, and will fully convey the scope of the invention to those skilled in the art. Similarly, the page displays of the user graphical interface are merely exemplary and may take many different forms. The following detailed description is not to be taken in a limiting sense.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “e-commerce website” is defined as a website through which a user may browse to purchase goods or services, where the user may select the goods or services for purchase, after which the goods or services are then placed within an electronic shopping cart. An “unrelated e-commerce website” is an e-commerce website that has an autonomous and independent implementation from another e-commerce website. Further, the websites have no common ownership, and there is no agreement or exchange of information between the websites or website owners. As used herein, an “electronic shopping cart” is defined as a virtual holder for the goods or services selected by a user, where the goods or services may be purchased by the user through a checkout procedure. A “checkout procedure” is when a user initiates the process of purchasing the selected goods or services. This includes, but is not limited to, entering billing, payment and shipping information, which the user may enter at that time or access previously stored information. A “single checkout procedure” is where the user is only required to perform the checkout procedure once to complete die purchase of the goods or services in the electronic shopping cart, even in the instance where the goods or services originate from two or more unrelated e-commerce websites. The user may complete the purchase of all the items in the electronic shopping cart or less than all of the items in the electronic shopping cart. The term “items” may be either goods or services including, but not limited to, airline reservations, hotel reservations and other commercial transactions capable of being accomplished through e-commerce Websites.

The following briefly describes the embodiments of the invention to provide a basic understanding of some aspects of the invention. This brief description is not intended as an extensive overview. It is not intended to identify key or critical elements, or to delineate or otherwise narrow the scope of the invention. Its purpose is merely to present some concepts in a simplified form.

One embodiment of the invention is a persistent, unified electronic shopping cart (“ESC”) that permits a user to select and aggregate goods or services for future purchase from two or more umrelated e-commerce websites, display and modify the contents of the ESC, and complete the purchase of the goods or services from the unrelated websites using the ESC. The user of the ESC is able to add and remove items from the electronic shopping cart, compare the prices, calculate shipping and calculate taxes for items from different e-commerce sites, move items to a wish list to save items for future purchase and calculate the total purchase price for all of the items in the ESC. The ESC is independent of the user's access point, such that any modifications to the shopping cart made on one device will also appear on any other devices after the user's credentials are verified. For example, a user may access the ESC from a desktop, laptop and handheld device.

In another embodiment of the invention, the ESC tracks all of the ordering information. The electronic shopping cart may facilitate tracking shipments, customer complaints and processing returns. The ESC may track shopping behaviors of the users, which may be used to provide information or advertisements, store recommendations and product recommendations to users and merchants.

Environment for Implementing the Invention

FIG. 1 shows the components of one embodiment of an environment in which the invention may be practiced. Not all of the components are required for any given implementation of the invention, and variations in the arrangement and types of components may be made without departing from the scope of the invention. As shown in FIG. 1, network 100 contains a plurality of client devices 102, 104 and 106 which may consist of desktop computers, laptop computers, tablet computers, cell phones and any other device that may be capable of establishing a communication link with Internet/Local Area Network/Wide Area Network 110 through a wired or wireless medium and runs an application program enabling the device to access e-commerce websites. The client devices may be linked to other Wide Area Networks and/or Local Area Networks. Wireless client devices 106 are connected to Internet/Local Area Network/Wide Area Network 110 through wireless network 108. The client devices may be capable of identifying their location to other devices within the various networks. For example, cellular phones can identify themselves through Mobile Identification Numbers, Electronic Serial Numbers or mobile phone numbers. Computer devices can identify themselves through network addresses or other device identifiers. The identifier information may be included in messages or information sent to other devices within the various networks so that communications can take place through the network between the devices. Such communication can take place through known communication methods such as Short Messaging Service (SMS). Multimedia Message Service (MMS), Instant Messaging (IM), Internet Relay Chat (IRC), Jabber or the like. Any suitable protocol or method of communication can be used to implement the current invention.

The client devices include application programs that send and receive web-pages, web-based messages, and data packets having content for updating the program and display of the client devices. The client devices may have operating systems that enable the application programs. The client devices may run a thin-client application program, such as ESC client 206. In one embodiment. ESC client 206 may be executed through a web browser. ESC client 206 may be a browser plug-in that is activated on execution of the browser program or activated at a later time. ESC client 206 is part of the portal for access to the web and thus may be independent of the E-Commerce websites.

The various networks may also include network devices that provide e-commerce websites such as e-commerce website servers 114, 116. The e-commerce website servers 114, 116 are capable of sending and receiving text, graphics, illustrations, photographs, web pages, multimedia information, and the like. These devices provide a website for the presentation, browsing, selection and purchasing of goods and/or services. Typically, e-commerce websites are accessed through a web browser. A web browser (commonly referred to as a browser) is a software application for retrieving, presenting and traversing information resources on the World Wide Web. The e-commerce website servers 114, 116 may contain their own electronic shopping cart implementation that works only on the particular c-commerce website or those of affiliated e-commerce website servers.

Local area network/wide area network/Internet 110 may couple e-commerce website servers 114, 116 to other computing devices including client devices 102, 104 and 106, and to ESC server 112. ESC server 112 may include any type of computing device capable of networking with local area network/wide area network/Internet 110 and enabled to communicate with various client devices and e-commerce servers. ESC server 112 communicates with ESC client 206 in each client device 102, 104 and 106. Information about the user's individual persistent electronic shopping cart server is stored at ESC server 112 and transferred to the client device and ESC client for display and modification by the user. ESC server 112 communicates with e-commerce website servers 114, 116 to collect a user's selection information regarding the goods or services selected at each e-commerce website, and to consummate the user's purchases of the goods or services in the ESC server 112 when the user checks out.

Local area network/wide area network/Internet 110 can use any form of computer readable media for communicating with the various electronic devices. The connections between the electronic devices can be through twisted pair, coax, fiber optics, satellite, carrier waves or any other commonly known medium. The communications can take place through routers and other networking equipment in a conventional manner. Further, the communications can have dynamic architectures and use any of a number of known protocols for communication.

FIG. 2 shows one embodiment of a client device 102. The client device includes central processing unit 202, RAM 204, input/output interface 212. ROM 222, and mass storage device 226. The various components are interconnected by bus 228. RAM 204 may contain various operating programs such as ESC client 206, operating system 208 and network interface 210. The network device communicates through Input/Output device 212. Input/Output device 212 can constitute a number of separate devices. For instance, it may contain a display 214, keypad 216, touch screen 218, network interface card 220, peripheral controllers and the like. ROM 222 may include a Basic Input/Output System (BIOS) 224 for controlling the low level operation of the device.

The network device of FIG. 2 may also contain mass storage 226 which can be hard drives, optical drives, memory chips or similar devices for storing large quantities of data in non-volatile memory. Mass storage 226 may also store other program code and data. One or more ESC clients 206 may be stored in mass storage 226 and then run within the environment of operating system 208.

Various aspects of the invention can be implemented in several different ways. For example, the invention can be implemented through a traditional client server arrangement or a peer-to-peer network architecture. The application program can be implemented in client devices, network-devices or any combination of various devices.

The ESC client of the present invention is a proprietary application software program that may be downloaded and installed on computers and handheld devices. The ESC client installed in client devices 102, 104, 106 works in tandem with ESC server 112 and e-commerce website servers 114, 116. The application may be run within any number of platforms or operating systems such as Microsoft Windows. Mac OS, Android, Linux or the like.

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

Generalized Operation

The ESC system in one embodiment may have ESC client 206 resident (pre-loaded) on a networked client device. If ESC client 206 is not pre-loaded on a network client device, a user may obtain ESC client 206 in various ways. As one example, a user may navigate to the ESC server 112 or a similar server having services for creating and accessing ESC accounts. The user may then create or sign in to an ESC account, download the ESC client and then install it on their client device. The ESC client will typically be a browser application plug-in that is active irrespective of the window that is open or the e-commerce website that is being accessed by the Web browser. The browser application may be integrated with the browser or may be an add-in. The ESC client may be programmed in any number of languages, which languages may be browser specific.

One embodiment of the implementation of the ESC client graphical user interface is shown in FIG. 3A. Browser window 302, which is a well-known browser application such as Firefox, Chrome, Safari, Internet Explorer or the like, may contain ESC icon 304 which, in this example, is located in the upper right corner of the interface screen. The icon may be any stylized shape. Also, the icon may change depending on the status of the ESC account and/or the status of the current e-commerce retailer visited as being affiliated with the ESC system. For example, if the user is not signed into the account, the icon may be shaded in red. When the user is signed into the account, the icon may change to green. When the user has items in the ESC account, the icon may also indicate the number of items in the shopping cart. Hovering over the icon with the cursor may raise expand the plugin 306, shown (in close up) in FIG. 3B. This screen provides the user with the option of logging into an existing ESC account using access credentials or creating a new ESC account. In one embodiment, the user may sign into their ESC account prior to shopping on the Internet. In another embodiment, the user may first complete their shopping on die Internet and then sign into their ESC account.

FIG. 4 shows one embodiment of the process flow for the operation of the ESC from the perspective of the user. The user first creates a ESC account and installs the ESC client, if not already present on the user's client device, as shown in block 402. In creating a ESC account, the user may optionally enter billing, payment and shipping information such as the billing address, preferred method of payment, shipping address, contact information and any other information typically required or optionally entered when items are purchased through e-commerce websites. The user may enter and store multiple credit cards, store-specific credit cards, gift cards and loyalty program cards. The system may automatically determine which payment method to use to maximize value to the end user and/or may provide the user with alternative suggestions. The user may also enter preferences, such as whether to receive advertisements, notifications, shipping confirmations and the like. Once the account is created, the user may then activate die account in block 404 by entering their user credentials, typically a username or email address and password. In block 406 the user may engage in shopping at e-commerce websites. While at such e-commerce websites, the user may select the goods or services to be placed in the cart and then add the item to the cart as shown in block 408. When the user completes their selection of goods or services, which the user has added to their ESC account, the user may checkout and complete the purchase transaction as shown in decision block 410 and block 412.

An example of welcome screen 502 with space for entry of the username/email address and password is shown in FIG. 5. After validation of the User's credentials, the user is shown ESC account status screen 602 in FIG. 6. ESC account status screen 602 allows the user to see the contents of the cart in area 604. In the particular example shown in FIG. 6, the ESC is empty and indicates that the user may add a product to the ESC to proceed. The user may navigate to a new screen within the ESC by clicking on cart icon 606. The user may expand account status screen 602 (before or after adding items to the ESC) by selecting the ESC icon. By clicking on wish list icon 608, the user may open a list of items saved for potential future purchases. These items may be shared by social network sites such as Twitter, Facebook and Pinterest, or through any other Web-based communications method like e-mail, text messages, . . . etc. There may also be icons for other features, such as customer feedback and a hyperlink to the user portal within ESC server 112. The user portal website may be used to track orders, handle billing disputes, process returns, contact the seller and manage account details, such as username, password, date of birth, gender, . . . etc. These capabilities may also be implemented through ESC client 206. The user may also sign out of the ESC account by selecting sign out icon 612.

The user may shop in e-commerce sites affiliated with the ESC by selecting shop icon 610. The ESC may provide discounts or incentives for shopping with affiliated e-commerce websites. ESC client 206 may also implement search functionality. The search may be for affiliated e-commerce websites, or may be an item search that will return results based on the status of carrier of the product as an affiliate or not.

The user may navigate to websites in any manner, not needing to access such websites through shop icon 610. FIG. 7 shows an example of a typical e-commerce website displaying an item for sale. After the user identifies the item they are seeking to purchase, the user selects add item to cart icon 702 to place the item in the ESC. As shown in FIG. 8, when the user clicks on ESC icon 304, ESC account status screen 602 is displayed to the user. ESC account status screen 602 is updated with the item the user added through the e-commerce website, which is summarized in area 604. The information about the item may include, for example, the e-commerce provider, a picture of the item, details about the item, the price and quantity. The user may preset or pre-select the information that appears in area 604. Several additional options are provided to the user. The user may choose to remove the item from the cart through remove icon 802, add the item to their wishlist through wishlist icon 804 or obtain more information about the item through product info icon 806. The user may at this point complete the checkout procedure by clicking on checkout icon 810. A summary of items, shipping cost, taxes and the order total for the items in the user's ESC account are provided to the user in order summary area 812.

The user may also continue shopping at other e-commerce sites. An example of navigating to second and third unrelated e-commerce websites is shown in FIGS. 9 and 11, with the updated ESC account shown in FIGS. 10 and 12. In one embodiment of this invention, the user enters the order information into the electronic shopping cart that is provided by the e-commerce website and then selects add to cart icon 902 in FIG. 9 or 802 in FIG. 11. As shown in FIG. 12, after the user has added items from each of the websites, all three of the selected items are shown in the ESC account. A scrollbar automatically appears when the information is too extensive to be displayed on the available pop-up window space. An item may be removed from the ESC account by clicking on remove icon 1302, as shown in FIG. 13. The ESC account will be automatically updated to show the new status of the ESC without the removed item.

When the user has completed their selection of items for purchase, they may select the checkout icon. This brings the user to order-summary screen 1402 in FIG. 14. The order summary screen shows a summary of the purchase, with the shipping address, payment method, shipping method, along with summary information for the purchase. Order summary screen 1402 may display any combination of information. The user may choose to edit the various selections by selecting edit buttons 1404, such as the shipping speed, the credit card information, the shipping address . . . etc. If credit card information, or any other information, has not been previously entered by the user, the user may edit or add such information. On selecting edit buttons 1404, a subsequent screen will appear with blanks for the information to be populated by the user. An example of a subsequent screen containing blank spaces for a user to enter their credit card information is shown in FIG. 15. When the user is satisfied that the information is complete, the user selects submit icon 1406. Thereafter, the user's purchase is completed by the ESC server and a summary screen may be displayed to the user, an example of which is shown in FIG. 16.

FIG. 17 shows the flow of information between ESC client 206, ESC server 112 and e-commerce websites 114, 116. Typically, the user will access e-commerce website 114 through client device 102 using web browser 1702. While browsing e-commerce website 114, client device 102 will also be running ESC client 206. ESC client 206 may either be a plug in to the browser or nm separately on client device 102. The user will navigate to a page that permits selection of an item being offered for sale. When the user clicks on an “add to cart” icon, for example, through the e-commerce website page's own add to cart icon or an ESC icon on the e-commerce website, ESC client 206 will exchange information with e-commerce website 114 and ESC sever 112 that the user has added an item into the ESC account 1704. In one embodiment, ESC client 206 will send identifier information to e-commerce website 114 indicating that the selection is to be placed in a ESC account. The ESC account may be the user's account, if the user has logged into their account prior to shopping, or may be a generic account if the user has not created an account or not yet logged into their account, e-commerce website 114 communicates with ESC server 112 such that the item is provisionally marked as reserved in e-commerce website 114 and provisionally credited to the ESC account in ESC server 112. The ESC system may have a time out feature that releases the provisional credit within a certain period of time. ESC server 112 will then send the selection information to ESC client 206 within client device 102. In another embodiment, ESC client 206 will send selection information to ESC server 112. ESC server 112 will communicate with e-commerce website 114 to provisionally mark the item as reserved in e-commerce website 114 and provisionally credit the item in ESC account 1704. Again, ESC account 1704 may be a generic account from which the user's ESC account will be updated after login or may be the user's account if the user has already logged in.

The user may then navigate to the ESC account home view by clicking on, for example, ESC icon 304. The item selected and associated information will then be displayed on the display of client device 102 as in the user's ESC. The ESC icon may also change to depict that one item is in the ESC. From the user's perspective, other than a change in the ESC icon and placing of the item in the ESC account, there are no visible changes—the user would remain on the e-commerce website page and may continue shopping.

At this point, the user may choose to checkout or may continue shopping at either e-commerce website 114 or change to a different and unrelated website such as e-commerce website 116. The same steps and procedures would take place for placing items within the user's ESC account as was done for e-commerce website 114.

Once the user has completed shopping and desires to checkout, the user will click on, for example, checkout icon 810 (FIG. 8). As shown in FIG. 17, if the user has not yet logged into to their account. ESC server 112 will verify the user's credentials to log them into their account or will create a new account for the user. Once verification is complete, ESC server 112 will create a summary of the order for confirmation by the user and transmit the information to ESC client 206 at client device 102. Client device 102 may then create a display of the summary information, as shown in FIG. 14. After the user confirms the desire to purchase the items, client device 102 communicates the confirmation to ESC server 112. ESC server 112 may then process the payment and communicates with each e-commerce website to complete the transaction. ESC server 112 may itself process the user's payment, may communicate with each e-commerce website to process the payment or may communicate with a third-party provider for payment processing.

As apparent, access to ESC account 1704 is independent of the client device. Thus, a user may use a home computer to add items to the ESC account, switch to a laptop to add other items to the ESC account and then use, for example, a tablet computer to checkout. The ESC account allows a user to enter their billing and shipping information once, and then use it to purchase items from any number of e-commerce websites. This saves the user from having to create multiple accounts across multiple e-commerce websites and/or to enter such information at each website.

Another benefit of having a centralized account, such as ESC account 1704, is that a consumer's purchasing behaviors may be aggregated not only at one e-commerce website, but across multiple unrelated websites. This permits an evaluation of the overall behavior of purchasing patterns. ESC Server may collect and aggregate consumer data such as, for example, age, gender, location, time of day that the shopping occurred, conversion rates, conversion times, browser habits, sites visited and purchasing decisions. This information may be used by advertisers to provide advertisements and promotions, or any other information, to the users of the ESC.

ESC server 112 may also provide affiliate advertising and marketing services or any other information to users through ESC client 205. Users may be presented with customized advertisements, promotions, coupons, product recommendations or the like through, for example, ESC account status screen 602. These advertisements, promotions, coupons and/or product recommendations may be customized based on the user's historical purchasing behaviors, which will become more predictive as more data is collected by ESC server 112. One method of providing recommendations for consumers is provided by Relevantis, Inc. of Kirkland, Wash. In this method of providing recommendations, vocabulary words are built from the e-commerce websites visited by the user factoring in actions taken by the user at such websites. A distribution is formed of prior probabilities statistically correlating the actions taken at the websites and providing a recommendation based on the correlation.

ESC Server 112 may also continually update the prices of items within the ESC account, may track various coupons and may even notify the user if a coupon was issued that may apply to items within the user's ESC account.

The aggregation of purchases also permits comparison of prices, handling fees, shipping fees, taxes, total price, warranties, return policies and customer reviews. A user may place the same or similar items in their ESC cart from several different e-commerce websites and compare each product offering to determine the best value for the particular consumer. The comparisons may be done manually by the user by employing filters or by an automated system wherein ESC Server 112 provides custom filters.

Although a user may use the invention described herein for goods and services from multiple, unrelated websites, a user may also use the ESC to purchase a single item from a single website. This is an advantage to the user since billing, payment and shipping information may already be within the ESC account, thereby making purchase simple and convenient.

Although other modifications and changes may be suggested by those skilled in the art, it is the intention of the inventors to embody within the patent warranted hereon all changes and modifications that reasonably and properly come within the scope of their contribution to the art.

We claim:

1. A method of purchasing comprising:
accessing two or more unrelated websites from a user device;
transmitting an identifier from the user device to the two or more unrelated websites;
transmitting information for purchasing items or services from each of the two or more unrelated websites to a server having an account associated with a user based on the identifier;
transmitting the information from the server to the user device;
displaying the information in an interface for purchasing the items or services from each of the two or more unrelated websites; and
transmitting the information to the two or more unrelated websites based on a single checkout procedure.

2. The method of claim 1 wherein the transmission of information to the two or more unrelated websites based on a single checkout procedure is accomplished either through the server which communicates with the two or more unrelated websites to complete the purchase or through the two or more unrelated websites which communicates with the server to complete the purchase.

3. The method of claim 1 wherein the account associated with the user is independent of the client device.

4. The method of claim 1 further comprising:
displaying a status icon for the persistent electronic shopping cart on the client device, where the status icon indicates whether the user credentials have been verified, whether the e-commerce website being visited is associated with the server or the number of items being tracked by the interface.

5. The method of claim 1 wherein the displaying of the informatin is enabled through a browser plugin.

6. The method of claim 1 further comprising:
processing payment for the orders through the server.

7. The method of claim 1 further comprising:
transmitting user identification information from the client device to two or more electronic commerce websites;
transmitting the user identification information with the order information to the persistent electronic shopping cart server.

8. The method of claim 7 wherein the placing of at least one of the orders is through an electronic shopping cart enabled by one of the electronic commerce websites, further comprising:
redirecting the order information to the persistent electronic shopping cart server based on the user identification information.

9. The method of claim 1 further comprising
aggregating purchase behavior information about the user from the two or more unrelated ecommerce websites; and
providing user-specific content to the user based on the aggregated purchase behavior information.

10. The method of claim 9 wherein the user-specific content is either recommendations for additional goods or services, advertisements, discounts or coupons.

11. A method of placing an order for items from two or more unrelated electronic commerce websites through an electronic network comprising:
accessing by a user through a client device a first electronic commerce website offering items for sale through the electronic network;
transmitting an identifier to the first electronic commerce website identifying the user as associated with a persistent electronic shopping cart server;
transmitting ordering information by the user for the items for sale to the electronic commerce website;
transmitting the identifier and ordering information from the first electronic commerce website to the persistent electronic shopping cart server;
accessing by the user a second electronic commerce website offering items for sale through the electronic network;
transmitting the identifier to the second electronic commerce website identifying the user;
transmitting ordering information by the user for the items for sale to the second electronic commerce website;
transmitting the identifier and ordering information from the second electronic commerce website to the persistent electronic shopping cart server;
transmitting the ordering information for the first and second electronic commerce websites from the persistent electronic shopping cart server to the user;
displaying the ordering information to the user in a persistent electronic shopping cart;
fulfilling the orders to the first and second ecommerce websites through one checkout procedure; and
wherein the first and second ecommerce websites are unrelated to one another.

12. The method of claim 11 further comprising:
displaying a status icon for the persistent electronic shopping cart on the client device, where the status icon indicates whether the user credentials have been verified, whether the e-commerce website has authority to exchange information with the electronic shopping cart server or the number of items in the user's persistent electronic shopping cart.

13. The method of claim 11 wherein the displaying of order information is enabled through a browser plug.

14. The method of claim 11 further comprising:
processing payment for the orders through the persistent electronic shopping cart server.

15. The method of claim 11 wherein the placing of at least one of the orders is through an electronic shopping cart enabled by one of the electronic commerce websites.

16. The method of claim 11 further comprising
aggregating purchase behavior information about the user from the two or more unrelated ecommerce websites; and
providing user-specific content to the user based on the aggregated purchase behavior information.

17. The method of claim 16 wherein the user-specific content is either recommendations for additional goods or services, recommendations for e-commerce websites, advertisements, discounts or coupons.

18. A system for shopping over a network comprising;
a plurality of client devices wherein each client device is configured to receive and send messages over the network and is operative to enable actions for
accessing two or more unrelated electronic commerce servers by a user;
placing orders for items using electronic shopping carts associated with the two or more unrelated electronic commerce servers;
transmitting persistent electronic shopping cart account information associated with the user to the two or more unrelated electronic commerce servers;
a network device that is in communication with the plurality of client devices, and is operative to enable actions for
receiving the orders for items and the persistent electronic shopping cart account information;
validating access permission by the user to the persistent electronic shopping cart account;
confirming the orders with the user; and
communicating with the two or more unrelated electronic commerce servers to complete the orders on behalf of the user based on a single checkout procedure.

19. The system of claim 18, the network device is operative to enable further actions for
generating promotions for e-commerce websites that are enabled to transmit orders for items to the network device; and
transmitting the promotions to the plurality of client devices.

20. The system of claim 18, the network device is operative to enable further actions for
storing historical purchasing information for orders placed through the persistent electronic shopping cart account; and
providing content specific to the persistent electronic shopping cart account based on the historical purchasing and browsing information.

21. A network device to manage communications over a network, comprising:
a transceiver to send and receive data over a network; and
a processor that is operative to enable actions for
storing order information placed by a user through electronic shopping carts associated with two or more unrelated ecommerce websites;
validating access credentials of the user to the single persistent electronic shopping cart;
transmitting the stored order information to a client device associated with the user so the stored order information may be displayed on the client device in a single persistent electronic shopping cart;
fulfilling the order by the user from the two or more unrelated ecommerce websites through one checkout procedure associated with the single persistent electronic shopping cart;
aggregating purchase behavior information about the user from the two or more unrelated ecommerce websites; and
providing user-specific content to the user based on the aggregated purchase behavior information.

22. The network device of claim 21, wherein the user-specific content is either recommendations for additional items, advertisements, discounts or coupons.

23. The network device of claim 21, wherein the process is further operative to enable actions for
generating promotions for e-commerce websites that are enabled to transmit the order information to the network device; and
transmitting the promotions to the client device.
